(19) United States
(12) Patent Application Publication
(10) Pub. No.: US 2005/0272337 A1
(43) Pub. Date: Dec. 8, 2005

(54) Artificial dielectric fabric

(76) Inventor: Dan Zabetakis, Brandywine, MD (US)

Correspondence Address: Naval Research Laboratory;Code 1008.2, 4555 Overlook Ave., S.W., Washington, DC, 20375-5320, US

(21) Appl. No.: 10/863,849

(22) Filed: Jun. 7, 2004

(51) Int. Cl. B32B 5/02

(52) U.S. Cl. 442/131; 442/63; 442/132; 442/133; 442/152

(57) ABSTRACT

Artificial dielectric material characterized by an organic matrix composed of woven and/or non-woven fibers coated with a metallic material wherein its dielectric constant varies with frequency.

### BACKGROUND OF THE INVENTION

1. Field of the Invention

This invention pertains to a metallized fabric which has the unique property of dielectric constant variation with frequency.

2. Description of Related Art

Various procedures exist for metallizing cloth or fabric. These include vapor deposition and electroless plating. Prior art in these fields relates to the production of a metal or metallic coating that will yield the properties of heat resistance, electromagnetic insulation or reflection or bulk conductivity.

While useful for the various applications for which they are intended, the dielectric constant of a metallic or conductive material is very high (e.g., above 10,000). These materials are not applicable to electromagnetic applications where low or medium dielectric constants are desired. High dielectric materials effectively exclude electromagnetic energy and can function as insulators simply by blocking the transmittance of such energy.

For purposes herein, a low dielectric constant is less than 3, a medium dielectric constant is 10-20 and a high dielectric constant is above 100.

Alternatively, a low or medium dielectric constant material will allow the penetration of the energy into the material where it may be attenuated by resonant cancellation or simply absorbed.

Furthermore, the dielectric constant of the prior art material being metallic, would tend to remain constant over any frequency range. This limits applicability since a certain dielectric constant is useful for only a small frequency in many systems. By contrast, the material produced by the techniques presented herein have a dielectric constant that varies with frequency. This will allow the insulating or attenuation effects to function over a broader range of frequencies.

Percolating composite materials typically use powders, microspheres or microcylinders in conjunction with a polymer matrix. Often, these composites require advanced technology, i.e., in terms of shape and size of particles, in order to produce a significant effect.

U.S. Pat. No. 5,607,743 discloses a metallized and electrically conducting gauze, deformed by deep drawing, based on a flat-shaped resin-coated textile material which has a metallized surface. The surface metal coating is up to 300 microns thick, although it is 20-100 microns thick in the preferred embodiment. The gauze product is made by impregnating a gauze fabric with a suitable resin suitable for mechanical stabilization and then pretreating the resin-coated gauze by activating it with a solution containing noble metal ions or noble metal colloid followed by acceleration treatment in an aqueous acid folowed by the step of depositing a metal such as copper, nickel or gold. The metal is deposited by treating the prepared gauze with an aqueous solution containing the relevant metal ions and a reducing agent. Another layer of same or different metal can then be deposited electrolytically on the chemically deposited metal layer.

The Browning et al article in Journal of Applied Physics, in Vol. 84, No. 11, on pp. 6109-6113, entitled “Fabrication and radio frequency characterization of high dielectric loss tubule-based composites near percolation” discloses microscopic lipid tubules with an average aspect ratio of about 12 that were metallized elecrolessly with copper or nickel-on-copper and mixed with vinyl to make composite dielectric panels. As loadings increased, the metal tubule composites desplayed an onset of electrical percolation with accompanying sharp increases in real and imaginary permitivities. Gravity-induced settling of the tubules, while the vinyl was drying, increased true loading density at percolation threshold for nickel/copper tubules to about 12 volume percent. This threshold was at a significantly lower loading density than that previously measured for percolation by composites containing spherical conducting particles. Qualitatively, the shape of the composite permitivity versus loading density curves followed predictions by the effective-mean field theory for conducting stick composites. Changes in permitivity of the vinyl panels were observed for several days after fabrication and were apparently associated with solvent evaporation from the matrix.

### OBJECTS AND BRIEF SUMMARY OF THE INVENTION

An object of this invention is a metallized artificial dielectric material with a dielectric constant of low, medium or high magnitude that is especially useful for electromagnetic applications.

Another object of this invention is a metallized fiber, woven or non-woven, wherein the metallized surface is provided by electroless plating wherein the motive force is imparted by a reducing agent.

Another object of this invention is a metallized fabric with non-continuous or semi-continuous electrically conducting path that can be used in the general electromagnetic insulation, isolation and/or absorbance fields.

Another object of this invention is a metallized fabric with a dielectric constant that varies with frequency.

These and other objects can be attained by a metallized fabric having a discontinuous electrical path wherein its dielectric constant varies with frequency in the range of 2 MHz to 40 GHz.

### BRIEF DESCRIPTION OF THE DRAWINGS

FIG. 1 shows limited variation in real and imaginary dielectric constants over the frequency range of up to 19 GHz at a loading of 5 minutes of electroless metal deposition.

FIG. 2 shows a pronounced variation in real and imaginary dielectric constants over the frequency range of up to 19 GHz at a loading of 10 minutes of electroless metal deposition.

FIG. 3 shows a more pronounced variation in real and imaginary dielectric constants over the frequency range of up to 19 GHz at a loading of 15 minutes of electroless metal deposition.

FIG. 4 shows a very pronounced variation in real and imaginary dielectric constants over the frequency range of up to 19 GHz at a loading of 20 minutes of electroless metal deposition.

FIG. 5 shows a dramatic variation in real and imaginary dielectric constants over the frequency range of up to 19 GHz at a loading of 25 minutes of electroless metal deposition.

### DETAILED DESCRIPTION OF THE INVENTION

The invention disclosed herein has properties of the percolating systems of materials. In these systems, an insulating matrix is combined with metal or metallic inclusions to form an artificial dielectric material. As the amount of metal or metallic inclusions increases, such materials approach the percolation threshold where they begin to take on the bulk properties of an electrical conductor. At and near the percolation threshold, these materials have unique dielectric properties that are useful in electromagnetic applications. The percolation threshold is defined as the situation where a non-conductive matrix (in this case the fabric) has enough metallic inclusions (in this case the plated metal) that it begins to take on the large scale properties of a conductor. Conventionally, it is defined as the point when the real and imaginary components of the dielectric constant are approximately equal within about 5 points.

An artificial dielectric material was fabricated conventionally from an organic matrix that can be a cloth or a fabric composed of common textile materials selected from natural materials such as cotton, wool, hemp, jute and synthetic material such as polybutadiene, polyester, acrylics, and the like. Hereinafter, fabric will be used to denote the organic matrix, be it a cloth or a fabric, woven or non-woven, and can be composed of any of the common textile materials. In the example given herein, the fabric was a white Kimberly-Clark Manufactured Rags brand Workhorse. This cotton fabric is described as a high pulp content non-woven composite fabric.

The fabric was first rinsed in water for about a quarter of an hour in order to hydrate the fibers and remove any loose or soluble matter that was present.

A commercial tin-palladium catalyst was then used to sensitize the fabric to the metal plating bath. In this case, the catalyst was Shipley Cataposit 44 and Cataprep 404. The amounts used followed the manufacturer's recommendation of 270 g/l for the solid Cataprep 404 and for liquid Cataposit 44, the final concentration of 0.9 5% by weight was used. Cataprep 404 can be used at concentrations of 50-300 μl whereas Cataposit 44 can be used at concentrations of 0.1-1.8%.

The fabric was agitated in the catalyst aqueous solution for a quarter of an hour during which time, the fabric changed in color from white to brown, i.e., the color of the palladium catalyst, indicating that the palladium catalyst was bound to the fibers of the fabric. The fabric was then rinsed with water to remove excess catalyst solution.

The fabric may be metallized with any plating bath, according to manufacturer's instructions. In this example, the plating bath was Shipley Cuposit 328 which was a multi-part aqueous solution for copper plating. The plating bath may be heated, according to the manufacturer's instructions, but it was found that plating at room temperature resulted in slower plating and allowed greater control over the level of plating.

Continuing with the procedure, the fabric was immersed in the plating bath and allowed to react for an amount of time appropriate for the level of metallization required. In this example, different samples were plated for 5, 10, 15, 20 and 25 minutes, yielding fabrics with low to high dielectric properties.

To terminate the plating reaction, the fabric was immersed in a large volume of water and then rinsed to remove residual plating bath. It was then air dried, with or without heating.

If desired, the fabric may be formed into a composite by the addition of an epoxy coating or other polymer treatment to yield rigidity or other mechanical properties.

The benefit of this disclosure lies in the properties of the resultant fabric product. The table below, i.e., Table 1, summarizes the dielectric properties of the samples in the example above at the frequency range of 2-19 GHZ.

TABLE 1

| Plating | Dielectric Constant | | Percolation | Frequency |
|---|---|---|---|---|
| Time | Real | Imaginary | Threshold | Dispersion |
| 5 | ˜2-5 | ˜0 | below | low |
| 10 | ˜4-6 | ˜0.5-1.0 | below | minor |
| 15 | ˜7-15 | ˜5-7 | near | strong |
| 20 | ˜50-<25 | ˜75-300 | above | strong |
| 25 | <50 | ˜250->1000 | above | strong |

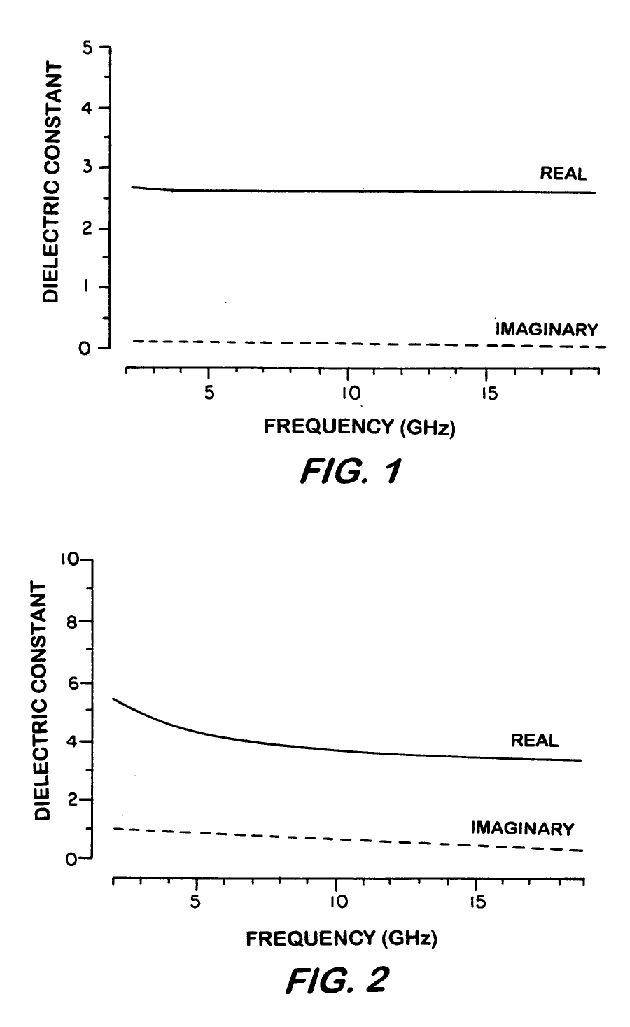

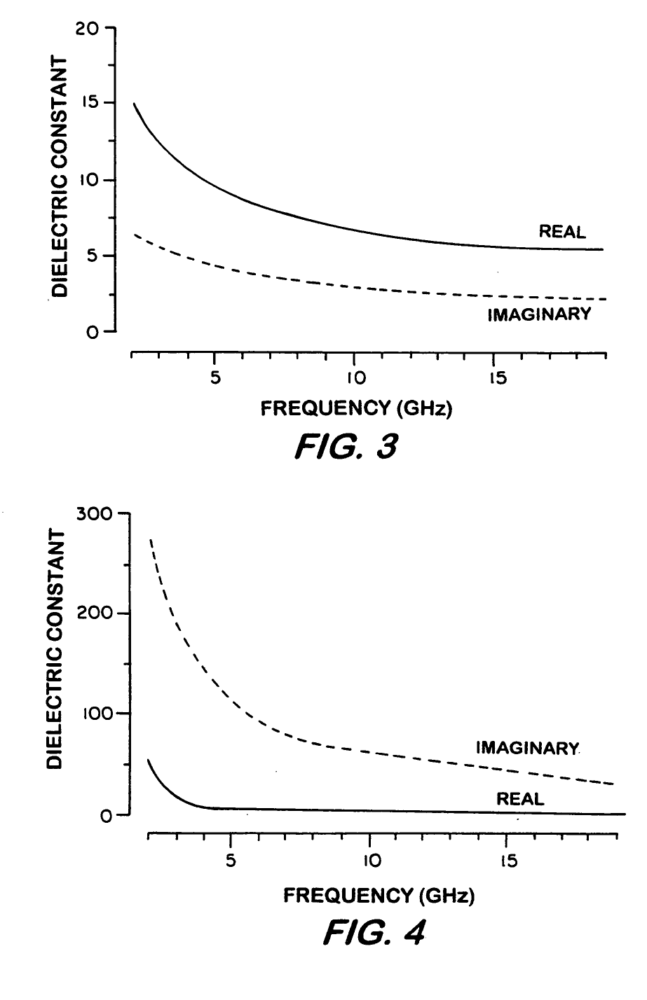

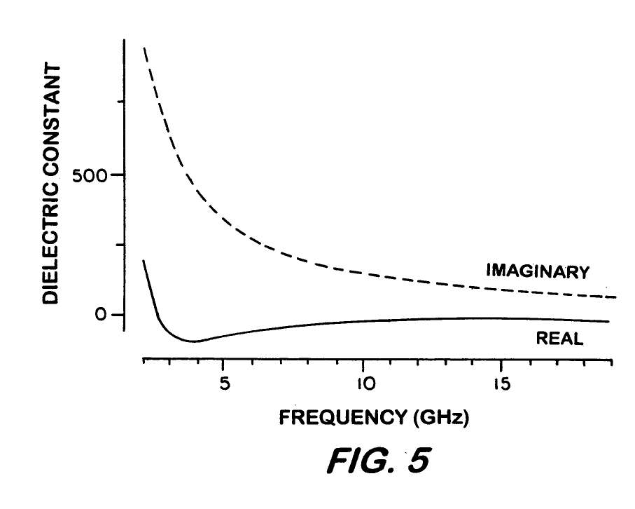

Measurements of dielectric constant as a function of frequency over the range of 2-19 GHz is shown in FIGS. 1-5 for plating times of 5-25 minutes. It should be noted that FIG. 5 shows dielectric constant variation with frequency for a material with a negative real dielectric constant. Such materials are the so-called “left handed” materials which, as theory suggests, can be used to make perfect lens and other products.

The examples summarized in Table 1, above, show the expected result that as the amount of metal increases, both the real and imaginary dielectric constants increase until the threshold at which the imaginary value rises dramatically while the real value decreases.

For purposes herein, useful dielectric constants are estimated to be in the range of 1-1000, typically 1-50, for the real dielectric constants and 0-1000, typically 0-50, for the imaginary dielectric constants over the microwave frequency range of 2-20 GHz. Thickness of the metallic coating is expected to be in the range of 0.05-50 microns.

Frequency dispersion is a measure of the change in dielectric constant with frequency. Most materials retain a dielectric constant that does not change across a frequency range. The materials described here demonstrate a variable dielectric constant over the range tested. The importance of this is that for an insulator/absorber of microwave energy to function at different frequencies (i.e., to be broadband), the optimal dielectric constant is different at each frequency. Hence, with this material, it is possible to design higher performance electromagnetic composites. Optimal dielectric constant for a particular frequency can be determined by trial and error.

The fact that dielectric constant varies with frequency allows insulating or attenuating effects to function over broader range of frequencies. This should be understood in the context of using multiple coatings each imparting a different dielectric constant that is effective for energy absorbance at a different frequency.

It is known from electromagnetic theory that optimal absorbance over a broad range of frequency is achieved with appropriate materials having a dielectric constant as a function of frequency. For best performance, the real component of the dielectric constant should vary as an inverse proportion to the square of the frequency, while the imaginary dielectric constant should vary as a simple inverse proportion to the frequency.

As already noted, at or near the percolating threshold, these materials have unique dielectric properties that are useful for electomagnetic applications. (elaborate).

Shielding from radar or antennae isolation are principal concerns for the artificial dielectrics of this invention which involve wave reflection or attenuation. One way to provide for antireflection is to provide a coating on a matrix which would produce at least two reflections of which, one would be off the matrix and one would be off the coating. Cancellation of the two waves causing the reflections is possible if the waves are 180° out of phase. Then the waves cancel each other out and in theory, the result can be zero reflection. However, in order to get the 180° out of phase reflection, the spacing between the reflecting matrix and the coating has to be ¼ of a wavelength of the impinging energy. A wavelength depends on frequency inversely. A material has a dielectric constant of greater than 1 since dielectric constant of air is 1 and a dielectric constant can change a wavelength. By controlling the wavelength of a microwave by means of a dielectric constant, the dielectric constant can thus control a wavelength. Although a typical microwave wavelength is about 3 centimeter, a quarter thereof is about 0.8 cm which is considerable and impractical cancellation spacing. However, in a dielectric material, a wavelength can shrink as much as ten fold allowing for wave cancellation and essentially zero reflection. For instance, if wavelength of 10 GHz radiation is 3 cm, its wavelength in a dielectric medium with a dielectric constant of 2 would be 2.1 cm; in a dielectric medium with a dielectric constant of 5, the wavelength would be 1.3 cm; for a medium with a dielectric constant of 10, the wavelength would be 9.5 mm; and for a medium with a dielectric constant of 25, the wavelength would be 6 mm. Thus, in a situation where maximum cancellation is desired, matrix dielectric constant is adjusted, as by matrix material selection, and thickness, and other adjustments are made in order to achieve the desired result.

Rather than plating uniformly across the fabric, it is possible to plate non-uniformly. Plating also can be limited to only one side of the fabric. Plating can be carried out in such a manner as to create a gradient of dielectric properties across the length or breadth of the fabric. It is also possible to pattern the fabric by various techniques and a complex geometric pattern of dielectric properties can thus be created.

Artificial dielectrics of this invention can be used in wearable antenna applications where radar shielding is a major concern and this invention has shown promise in gain enhancement and radiation hazard reduction and particularly in antenna isolation or shielding.

While presently preferred embodiment have been shown of the novel artificial dielecrics, and of the several modifications thereof, persons skilled in this art will readily appreciate that various additional changes and modifications can be made without departing from the spirit of the invention, as defined and differentiated by the following claims.

1. An artificial dielectric article comprising a matrix coated with a metallic material wherein dielectric constant of said article varies with frequency.

2. The article of claim 1 wherein said matrix is organic composed of a network of woven and/or non-woven organic fibers.

3. The article of claim 2 wherein thickness of said metallic material is in the range of 0.05-50 microns and dielectric constant of said article is in the range of 1-1000 real dielectric constants and 0-1000 imaginary dielectric constants.

4. The article of claim 3 wherein said metallic material is selected from the group consisting of metallic particles, alloy particles, and mixtures thereof.

5. The article of claim 1 wherein the dielectric constant variation with frequency extends over frequency range of 2 MHz to 40 GHz.

6. The article of claim 2 wherein said metallic material is selected from electrically conducting metals.

7. The article of claim 2 wherein said metallic material is selected from the group consisting of copper, nickel, gold, iron, silver and mixtures thereof.

8. The article of claim 6 wherein its real and imaginary dielectric constants are about equal.

9. The article of claim 7 wherein said matrix is a network of woven fibers.

10. The article of claim 7 wherein said matrix is a network of non-woven fibers bound by an organic polymeric medium.

11. The article of claim 10 wherein its real dielectric constant varies from a negative value up to 1000 over the frequency range of 2 MHz to 40 GHz.

12. The article of claim 19 wherein said matrix is composed of any of the common textile materials and mixtures thereof.

13. The article of claim 7 wherein said a high pulp content non-woven composite fabric.

14. The article of claim 7 wherein said matrix is a cotton material.

15. A metallized fabric comprising a matrix composed of a common testile material or a mixture thereof coated with a metallic material wherein dielectric constant of said fabric varies with frequency.

16. The fabric of claim 15 wherein said matrix is organic composed of a network of woven and/or non-woven organic fibers.

17. The fabric of claim 16 wherein said metallic material is selected from the group consisting of metallic particles, alloy particles, and mixtures thereof.

18. The fabric of claim 17 wherein said metallic material is selected from electrically conducting metals.

19. The fabric of claim 18 wherein said metallic material is selected from the group consisting of copper, nickel, gold and mixtures thereof.

20. The fabric of claim 18 wherein the dielectric constant variation with frequency extends over frequency range of 2 MHz to 40 GHz.
